(19) United States
(12) Patent Application Publication
(10) Pub. No.: US 2025/0370654 A1
(43) Pub. Date: Dec. 4, 2025

(54) SYSTEMS, METHODS, AND APPARATUS FOR MEMORY USAGE BASED ON DATA ACCESS CHARACTERISTICS AND MEMORY ENDURANCE CHARACTERISTICS

(71) Applicant: Samsung Electronics Co., Ltd., Suwon-si (KR)

(72) Inventor: Pyeongwoo LEE, Sunnyvale, CA (US)

(21) Appl. No.: 19/223,000

(22) Filed: May 29, 2025

Related U.S. Application Data
(60) Provisional application No. 63/653,207, filed on May 29, 2024.

(51) Int. Cl. G06F 3/06

(52) U.S. Cl. CPC G06F 3/0655; G06F 3/0604; G06F 3/0679

(57) ABSTRACT

A device may include a memory, and a device controller configured to perform one or more operations may include storing, in a page of the memory, data, wherein the storing the data may be based on an access characteristic of the data, and an endurance characteristic of the page of the memory. The device controller may be configured to perform one or more operations including storing, in a second page of the memory, second data, wherein the storing the second data may be based on a second access characteristic of the second data, and a second endurance characteristic of the second page of the memory. The device controller may be configured to determine the endurance characteristic of the page of the memory based on a structure of the memory. The device controller may be configured to determine the endurance characteristic of the page of the memory based on an indication.

### REFERENCE TO RELATED APPLICATION

This application claims priority to, and the benefit of, U.S. Provisional Patent Application Ser. No. 63/653,207 filed May 29, 2024 which is incorporated by reference.

### TECHNICAL FIELD

This disclosure relates generally to memory usage, and more specifically to systems, methods, and apparatus for memory usage based on data access characteristics and memory endurance characteristics.

### BACKGROUND

Some types of memory devices may be arranged in blocks that may wear out after a certain number of program/erase cycles. If a first block in such a memory device is programmed and erased more frequently than other blocks, the first block may wear out before the other blocks, thereby reducing the capacity of the memory device.

The above information disclosed in this Background section is only for enhancement of understanding of the background of the inventive principles and therefore it may contain information that does not constitute prior art.

### SUMMARY

A device may include a memory, and a device controller configured to perform an operation may include storing, in a page of the memory, data, wherein the storing the data may be based on an access characteristic of the data, and an endurance characteristic of the page of the memory. The access characteristic may include an access frequency, and the endurance characteristic may include a number of program cycles. The data may include first data, the page of the memory may be a first page of the memory, the access characteristic may be a first access characteristic, the endurance characteristic may be a first endurance characteristic, and the device controller may be configured to perform one or more operations including storing, in a second page of the memory, second data, wherein the storing the second data may be based on a second access characteristic of the second data, and a second endurance characteristic of the second page of the memory. The device controller may be configured to determine the endurance characteristic of the page of the memory based on a structure of the memory. The device controller may be configured to determine the endurance characteristic of the page of the memory based on an indication. The device controller may be configured to determine the endurance characteristic of the page of the memory based on monitoring the page of the memory. The device controller may be configured to determine the access characteristic of the data based on monitoring one or more accesses of the data. The device controller may be configured to receive an indication, and determine the endurance characteristic of the page of the memory based on the indication. The storing the data may be further based on a utilized amount of the memory. The data may include first data, the page of the memory may include a first page of the memory, and the device controller may be further configured to perform one or more operations including storing, in a second page of the memory, second data, wherein the first page of the memory may be determined based on a first utilized amount of the memory, and the second page of the memory may be determined based on a second utilized amount of the memory. The device controller may be configured to perform, based on the storing the data, a garbage collection operation on the page of the memory.

A device may include a memory may include a first page having a first endurance characteristic and a second page having a second endurance characteristic, and a device controller configured to perform one or more operations including storing, in the first page of the memory, based on a first utilized amount of the memory, first data, and storing, in a second page of the memory, based on a second utilized amount of the memory, second data. The storing the first data may be based on a first access characteristic of the first data, and the storing the second data may be based on a second access characteristic of the second data. The device controller may be further configured to perform one or more operations including operating, based on the first utilized amount of the memory, a first group of pages of the memory may include the first page of the memory, and operating, based on the second utilized amount of the memory, a second group of pages of the memory may include the second page of the memory. The first group of pages may be based on one or more of a structure of the memory or an indication stored in the memory.

A method may include storing, in a page of a memory, data, wherein the storing the data may be based on an access characteristic of the data, and an endurance characteristic of the page of the memory. The data may include first data, the page of the memory may be a first page of the memory, the access characteristic may be a first access characteristic, the endurance characteristic may be a first endurance characteristic, and the method may further include storing, in a second page of the memory, second data, wherein the storing the second data may be based on a second access characteristic of the second data, and a second endurance characteristic of the second page of the memory. The endurance characteristic of the page of the memory may be determined based on at least one of a structure of the memory, an indication, or monitoring the page of the memory. The access characteristic of the data based on one or more of an indication or monitoring one or more accesses of the data. The storing the data may be further based on a utilized amount of the memory. The data may include first data, and the page of the memory may include a first page of the memory, and the method may further include storing, in a second page of the memory, second data, wherein the first page of the memory may be determined based on a first utilized amount of the memory, and the second page of the memory may be determined based on a second utilized amount of the memory.

### BRIEF DESCRIPTION OF THE DRAWINGS

The figures are not necessarily drawn to scale and elements of similar structures or functions may generally be represented by reference indicators ending in, and/or containing, the same digits, letters, and/or the like, for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates a bar graph of example endurance characteristics for wordlines in a block of memory in accordance with example embodiments of the disclosure.

FIG. 2 illustrates an embodiment of a memory apparatus having page usage based on data characteristics and page endurance in accordance with example embodiments of the disclosure.

FIG. 3 illustrates an embodiment of a scheme for storing data in pages of memory based on access characteristics of the data and/or endurance characteristics of the pages of memory in accordance with example embodiments of the disclosure.

FIG. 4A illustrates an embodiment of a scheme for allocating pages of a memory having a first utilization based on data access characteristics and endurance characteristics of the pages of memory in accordance with example embodiments of the disclosure.

FIG. 4B illustrates the embodiment of the scheme illustrated in FIG. 4A at a second utilization in accordance with example embodiments of the disclosure.

FIG. 5A illustrates an embodiment of a scheme for allocating pages of a memory having a first utilization based on endurance characteristics of the pages of memory in accordance with example embodiments of the disclosure.

FIG. 5B illustrates the embodiment of the scheme illustrated in FIG. 5A at a second utilization in accordance with example embodiments of the disclosure.

FIG. 6 illustrates an example embodiment of a system including a storage device that may implement one or more wear leveling techniques based on a data access characteristic and/or memory endurance characteristic in accordance with example embodiments of the disclosure.

FIG. 7 illustrates an example embodiment of a storage device controller and related apparatus that may implement one or more wear leveling techniques based on one or more data access characteristics and/or memory endurance characteristics in accordance with example embodiments of the disclosure.

FIG. 8A illustrates an example histogram of accesses of pages in a memory at a first operating point in accordance with example embodiments of the disclosure.

FIG. 8B illustrates the example histogram illustrated in FIG. 8A at a second operating point.

FIG. 9 illustrates an embodiment of a method for generating a page address in accordance with example embodiments of the disclosure.

FIG. 10 illustrates an embodiment of a method for generating a page number in accordance with example embodiments of the disclosure.

### DETAILED DESCRIPTION

Some types of memory devices may be arranged in blocks that may wear out after a certain number of program/erase (P/E) cycles. If a first block in a memory device is programmed and erased more frequently than other blocks, the first block may wear out before the other blocks, thereby reducing the capacity of the memory device and/or reducing the life of a memory system or storage device in which the memory device is located.

A wear leveling technique may be used to distribute P/E cycles across blocks in a memory device (e.g., relatively evenly across some or all blocks). This may prevent the uneven use of one or more specific blocks and/or cause blocks to wear out at about the same rate and/or time, thereby improving the lifetime of a memory system or storage device in which the memory device is located.

Some pages within a block of memory (which may be accessed using different wordlines) may be more durable (e.g., capable of more P/E cycles) than other pages within the block. A page that is capable of a relatively high number of P/E cycles may be referred to as a strong page (or a strong wordline), and a page that is capable of a relatively low number of P/E cycles may be referred to as a weak page (or a weak wordline). The absolute and/or relative strength of a page may be determined, for example, based on a location of a wordline with a structure of the memory, an indication based on a manufacturing process, and/or monitoring an operation of the page as described in more detail below.

Wear leveling algorithms may not differentiate between different pages within a block of memory. Thus, a block of memory may be retired (e.g., treated as worn out) when the weakest page wears out. However, this may prevent the use of other pages within the block that may still be capable of additional P/E cycles.

Some aspects of the disclosure relate to methods and apparatus that may store data in a page of memory based on an access characteristic of the data and/or an endurance characteristic of the page of memory. For example, in some embodiments, data that may be accessed relatively frequently may be stored in a page of memory having a relatively high endurance (e.g., using a strong wordline). Additionally, or alternatively, data that may be accessed relatively infrequently may be stored in a page of memory having a relatively low endurance (e.g., using a weak wordline). Depending on the implementation details, this may improve the reliability, lifespan, performance, and/or the like, of a memory device, memory system, storage device, and/or the like, for example, by enabling relatively strong wordlines to be used for more P/E cycles than relatively weak wordlines.

Some additional aspects of the disclosure relate to methods and apparatus that may store data in one or more pages of memory based on a utilization of the memory (e.g., a utilized amount of the memory which may also be referred to as a filled or occupied amount of the memory). For example, in some embodiments, in a memory having a relatively low utilization, data may be stored mostly in pages of the memory having relatively strong wordlines. Additionally, or alternatively, as the utilization of the memory increases, data may be stored in progressively more pages of the memory having relatively weak wordlines. Depending on the implementation details, this may improve the reliability, lifespan, performance, and/or the like, of a memory device, memory system, storage device, and/or the like, for example, by enabling relatively strong wordlines to be used for more P/B cycles than relatively weak wordlines.

Some additional aspects of the disclosure relate to techniques for determining an access characteristic of data that may be stored in a memory. For example, in some embodiments, accesses of data stored at one or more addresses in a memory may be monitored and/or binned to create a histogram representing a cumulative access frequency of the data. As another example, in some embodiments, a source of data (e.g., a host) may provide an indication (e.g., a hint) representing a likely or expected access frequency of the data. Depending on the implementation details, such techniques may be used to classify data as being relatively frequently or in frequently accessed.

Some additional aspects of the disclosure relate to techniques for determining endurance characteristics of pages of memory. For example, in some embodiments, an endurance characteristic of a page of memory may be determined by the location of a corresponding wordline with a structure of the memory. As another example, in some embodiments, an endurance characteristic of a page of memory may be determined from an indication based on a manufacturing process, testing process, and/or the like. Such an indication may be stored, for example, in a portion (e.g., a reserved portion) of the memory. As a further example, an endurance characteristic of a page of memory may be determined by monitoring one or more operations of the page of memory (e.g., based on an error correction code (ECC) failure rate). Depending on the implementation details, such techniques may be used to classify one or more pages and/or corresponding wordlines as being relatively strong or weak.

This disclosure encompasses numerous aspects relating to memory usage based on data access characteristics and memory endurance characteristics. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such three-dimensional (3D) not-AND (NAND) flash memory in a storage device. However, the aspects of the disclosure are not limited to these or any other implementation details,

In some embodiments described herein, reference indicators having a base portion and a suffix portion may be referred to collectively and/or individually by the base portion. For example, referring to FIG. 2, memory devices 206-1, 206-2, . . . may be referred to individually and/or collectively as 205. In some example embodiments described herein, multiple figures having the same numbers with different letter suffixes may be referred to collectively and/or individually by the number. In some example embodiments described herein, single or multiple instances of an element may be referred to collectively and/or individually as “a” and/or “the.” For example, one or more memory apparatus may be referred to as the memory apparatus or a memory apparatus. Similarly, one or more devices may be referred to as the device or a device.

In some embodiments, a page may refer to one or more memory cells that may be accessed (e.g., written and/or read) as a unit, for example, using a wordline. In some embodiments, the terms wordline and page may be used interchangeably unless otherwise apparent from context.

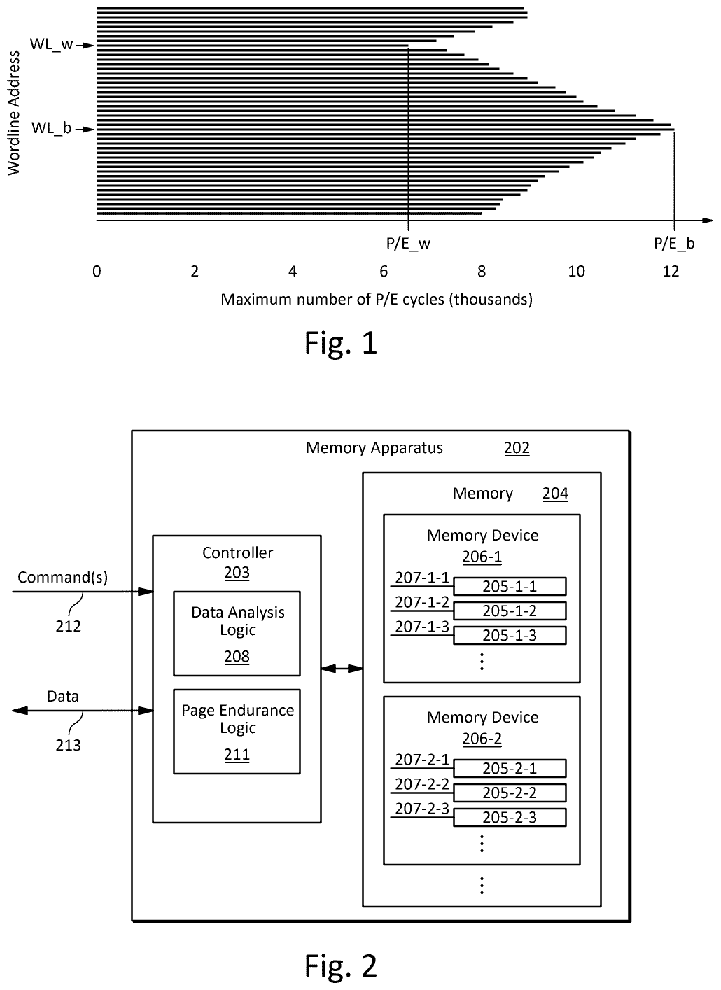

FIG. 1 illustrates a bar graph of example endurance characteristics for wordlines in a block of memory in accordance with example embodiments of the disclosure. The bars illustrated in FIG. 1 indicate the endurance of various wordlines (and associated pages of memory) in the block in terms of the number of P/E cycles each wordline may be subjected to before the reliability of the wordline drops below an acceptable level. The variation in endurance between the various wordlines may be caused by various factors such as process variations during a manufacturing process. For example, in the case of 3D NAND flash memory, a channel hole etched through multiple layers of wordlines may have different sizes and/or shapes at different layers, thereby resulting in variations between the endurance characteristics of the memory cells at different layers.

Referring again to FIG. 1, the wordline with the worst endurance indicated by WL_w may be capable of P/E_w cycles, and the wordline with the best endurance indicated by WL_b may be capable of P/E_b cycles. In some embodiments, the block of memory having endurance characteristics illustrated in FIG. 1 may be retired when the block has been subjected to P/E_w cycles, and thus, the P/E cycles of other wordlines represented by the portions of the corresponding bars extending to the right of P/E_w may be wasted.

FIG. 2 illustrates an embodiment of a memory apparatus having page usage based on data characteristics and page endurance in accordance with example embodiments of the disclosure. Memory apparatus 202 may include a controller 203 and a memory 204. Memory 204 may include one or more memory devices 206-1, 206-2, . . . . One or more (e.g., each) of memory devices 206 may include one or more pages 205-1-1, 205-1-2, . . . of memory. One or more (e.g., each) of pages 205 may be accessed using a corresponding wordline 207-1-1, 207-1-2, . . .

Controller 203 may receive data access commands 212 (e.g., read and/or write commands, load and/or store commands, and/or the like) that may cause the controller to write data 213 to memory 204 and/or read data 213 from memory 204.

In some embodiments, controller 203 may include data analysis logic 208 which may determine one or more access characteristics of data (e.g., an access frequency) to enable controller 203 to determine one or more pages 205 in which to store the data. For example, controller 203 may implement one or more wear leveling techniques in which relatively frequently accessed data may be stored in one or more relatively strong pages 205 and/or relatively infrequently accessed data may be stored in one or more relatively weak pages 205. An access characteristic of a page may be determined, for example, based on monitoring one or more access of the page, and/or based on an indication (e.g., a hint from a host) as described in more detail below.

Additionally, or alternatively, controller 203 may include page endurance logic 211 that may determine one or more endurance characteristics of one or more pages 205 to enable controller 203 to determine one or more pages 205 in which to store data, for example, to implement one or more wear leveling techniques in which relatively frequently accessed data may be stored in one or more relatively strong pages 205 and/or relatively infrequently accessed data may be stored in one or more relatively weak pages 205. Depending on the implementation details, data analysis logic 208 and/or page endurance logic 211 may improve the reliability, lifespan, performance, and/or the like, of memory 204, for example, by enabling relatively strong wordlines to be used for more P/E cycles than relatively weak wordlines. In some embodiments, this may reduce or eliminate the waste of P/E cycles of memory pages as described above with respect to FIG. 1. The absolute and/or relative strength of a page may be determined, for example, based on a location of a wordline with a structure of the memory, an indication based on a manufacturing process, and/or monitoring an operation of the page as described in more detail below.

Additionally, or alternatively, page endurance logic 211 may determine one or more endurance characteristics of one or more pages 205 to enable controller 203 to implement a memory allocation scheme in which one or more pages 205 of memory 204 may be used based on a utilization of the memory 204. For example, when memory 204 has a relatively low utilization, data may be stored mostly or entirely in relatively strong pages 205 of the memory 204. As the utilization of the memory 204 increases, data may be stored in progressively more relatively weak pages 205 of the memory 204. Depending on the implementation details, this may improve the reliability, lifespan, performance, and/or the like, of memory 204, for example, by enabling relatively strong wordlines to be used for more P/E cycles than relatively weak wordlines. In some embodiments, this may reduce or eliminate the waste of P/E cycles of memory pages as described above with respect to FIG. 1.

Although the memory apparatus 202 and/or components thereof are not limited to any specific implementation details, in some embodiments, the memory apparatus 202 may be implemented with a storage device (e.g., a storage drive such as a solid state drive (SSD)), a memory module such as a dual inline memory module (DIMM), a relatively small removable device which may also be implemented with and/or referred to as a Universal Serial Bus (USB) drive, a memory stick, a thumb drive, and/or the like, or any other type of apparatus that may utilize memory 204 that may implement one or more wear leveling techniques based on a data access characteristic and/or memory endurance characteristic in accordance with example embodiments of the disclosure.

Controller 203, data analysis logic 208, and/or page endurance logic 211 may be implemented with one or more circuits in any suitable form such as at least one processing circuit (e.g., processor), field programmable gate array (FPGA), application specific integrated circuit (ASIC), complex programmable logic device (CPLD), dedicated or shared portion of an integrated circuit, and/or the like, which may include one or more functional portions such as a media translation layer (e.g., a flash translation layer (FTL)), memory device controller (e.g., flash controller) and/or the like, as described in more detail below.

Memory 204 may be implemented with any type of memory, especially memory that may have one or more characteristics (e.g., endurance characteristics) that may implement, and/or benefit from, wear leveling techniques including the techniques relating to data access characteristics, page endurance characteristics, and/or the like, disclosed herein. Examples may include NAND flash memory, not-OR (NOR) flash memory, persistent memory (PMEM) such as cross-gridded nonvolatile memory, memory with bulk resistance change, phase change memory (PCM), and/or the like, or any combination thereof.

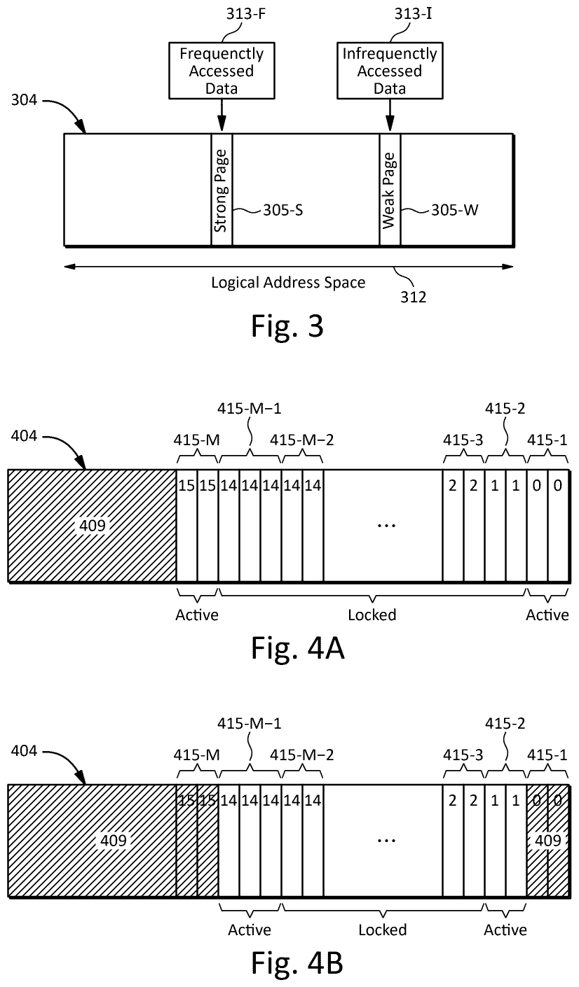

FIG. 3 illustrates an embodiment of a scheme for storing data in pages of memory based on access characteristics of the data and/or endurance characteristics of the pages of memory in accordance with example embodiments of the disclosure. The scheme illustrated in FIG. 3 may be implemented with, or be used to implement, for example, the apparatus illustrated in FIG. 2 and/or other figures in which similar elements may be indicated by reference indicators ending in, and/or containing, the same digits, letters, and/or the like. In some embodiments, one or more of the operations described with respect to FIG. 3 may be performed by a controller such as controller 203 illustrated in FIG. 2.

Referring to FIG. 3, a memory 304 may include a strong page 305-S having a relatively high endurance (e.g., high number of remaining P/E cycles) and a weak page 305-W having a relatively low endurance (e.g., low number of remaining P/E cycles). Pages 305-S and/or 305-W may be located in a logical address space 312 represented by the horizontal direction of memory 304. Depending on the implementation details, the logical address space 312 may or may not correspond to a physical address space. Moreover, in some embodiments, pages 305-S and 305-W may be located in the same erase block (or other unit of reclamation), whereas in other embodiments, pages 305-S and 305-W may be located in different erase blocks.

Frequent data 313-F (e.g., data that may be read and/or written relatively frequently, recently, and/or the like) may be stored in strong page 305-S. Additionally, or alternatively, infrequent data 313-I (e.g., data that may be read and/or written relatively infrequently, less recently, and/or the like) may be stored in weak page 305-W.

FIG. 4A illustrates an embodiment of a scheme for allocating pages of a memory having a first utilization based on data access characteristics and endurance characteristics of the pages of memory in accordance with example embodiments of the disclosure. FIG. 4B illustrates the embodiment of the scheme illustrated in FIG. 4A at a second utilization in accordance with example embodiments of the disclosure,

The scheme illustrated in FIG. 4 may be implemented with, or be used to implement, for example, the apparatus illustrated in FIG. 2 and/or other figures in which similar elements may be indicated by reference indicators ending in, and/or containing, the same digits, letters, and/or the like. In some embodiments, one or more of the operations described with respect to FIG. 4 may be performed by a controller such as controller 203 illustrated in FIG. 2.

The scheme illustrated in FIG. 4 may be used to control the order in which pages of memory 404 are filled with data and/or reclaimed for use (e.g., through garbage collection) which, depending on the implementation details, may improve or optimize the reliability, lifespan, performance, and/or the like, of memory 404. For example, as described in more detail below, the scheme illustrated in FIG. 4 may initially and/or preferentially use strong wordlines to store data when the utilization of memory 404 is relatively low, then gradually use weaker wordlines to store data as the utilization approaches the capacity of memory 404.

At the first utilization level illustrated in FIG. 4A, a portion 409 of memory 404 may be utilized (e.g., occupied with stored data). Some or all of the unoccupied portion of memory 404 may be arranged in one or more groups (e.g., a number M of groups) 415 of pages having the same or similar endurance indicated by an endurance index. In the example illustrated in FIG. 4A, indexes may range from 0 through 15 with index 0 indicating a lowest endurance (weakest pages) and index 15 indicating a highest endurance (strongest pages), but any type, range, and/or the like, of indexes may be used. Page group 415-M may include two pages having an endurance index 15, page group 415-M-1 may include three pages having an endurance index 14, page group 415-M-2 may include two pages having an endurance index 14, page group 415-2 may include two pages having an endurance index 1, and page group 415-1 may include two pages having an endurance index 0. Memory 404 may include any number of other page groups including any numbers of pages having any endurance indexes indicated by the ellipses ( . . . ).

To control the sequence in which pages in the unoccupied portion of memory 404 are filled with data, some pages and/or page groups 415 may be activated (e.g., to enable data to be stored in them), while other pages and/or page groups 415 may be locked (e.g., to prevent data from being stored in them). For example, as illustrated in FIG. 4A, page groups 415-M and/or 415-1 may be activated such that frequently accessed data may be stored in one or more pages in page group 415-M, and infrequently accessed data may be stored in one or more pages in page group 415-1, whereas page groups 415-M-1 through 415-2 may be locked (e.g., not available to store data).

As active pages and/or page groups become filled with data, the scheme illustrated in FIG. 4 may unlock additional pages and/or page groups in a sequence that, depending on the implementation details, may improve or optimize improve or optimize the reliability, lifespan, performance, and/or the like, of memory 404.

For example, referring to FIG. 4B, page group 415-M may be effectively filled (e.g., unable to receive additional write data), and thus, page group 415-M-1 (e.g., the next strongest wordlines) may be activated to receive additional write data (e.g., relatively frequently accessed data). Additionally, or alternatively, page group 415-1 may be effectively filled (e.g., unable to receive additional write data), and thus, page group 415-2 (e.g., the next weakest wordlines) may be activated to receive additional write data (e.g., relatively infrequently accessed data), Page groups 415-M-2 through 415-3 may remain locked, for example, until one or both of page groups 415-M-1 and/or 415-2 are filled.

Within a page group 415, pages may be allocated (e.g., filled) using various techniques. For example, the three pages 405 within page group 415-M-1 may be allocated sequentially based on logical addresses, physical addresses, and/or the like. As another example, pages within a group may be allocated randomly. As a further example, pages within a page group may be allocated based on a finer-grained endurance characteristic. E.g., even though some pages having a similar endurance may be arranged in a page group, the pages within the group may still have different endurances that may be used to determine an order in which the pages may be allocated.

Memory 404 may be arranged in a logical address space represented by the horizontal direction of memory 404. Depending on the implementation details, the logical address space may or may not correspond to a physical address space. For example, in some embodiments, a controller may translate logical addresses (e.g., logical block addresses (LBAs)) to physical addresses (e.g., physical block addresses (PBAs)) that may be scattered throughout 404. Thus, even though three pages in page group 415-M-1 may be illustrated as being adjacent in FIG. 4, the three pages may be scattered throughout, and/or within, different memory devices (e.g., dies), planes, blocks (e.g., erase blocks), and/or the like, within memory 404.

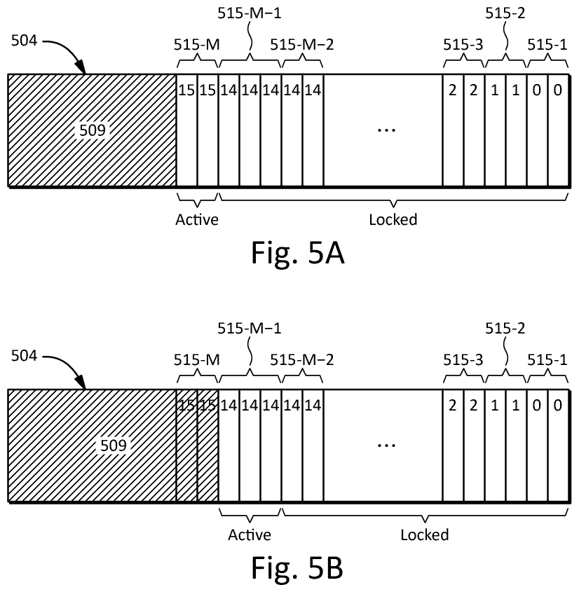

FIG. 5A illustrates an embodiment of a scheme for allocating pages of a memory having a first utilization based on endurance characteristics of the pages of memory in accordance with example embodiments of the disclosure. FIG. 5B illustrates the embodiment of the scheme illustrated in FIG. 5A at a second utilization in accordance with example embodiments of the disclosure.

The scheme illustrated in FIG. 5 may be implemented with, or be used to implement, for example, the apparatus illustrated in FIG. 2 and/or other figures in which similar elements may be indicated by reference indicators ending in, and/or containing, the same digits, letters, and/or the like. In some embodiments, one or more of the operations described with respect to FIG. 5 may be performed by a controller such as controller 203 illustrated in FIG. 2.

The scheme illustrated in FIG. 5 may be used to control the order in which pages of memory 504 are filled with data and/or reclaimed for use (e.g., through garbage collection) which, depending on the implementation details, may improve or optimize the reliability, lifespan, performance, and/or the like, of memory 504. For example, as described in more detail below, the scheme illustrated in FIG. 5 may initially and/or preferentially use strong word lines to store data in strong pages regardless of an access characteristic (e.g., frequency of use) of the data, then gradually use weaker wordlines to store data as the utilization increases toward the capacity of memory 504.

At the first utilization level illustrated in FIG. 5A, a portion 509 of memory 504 may be utilized (e.g., occupied with stored data). Some or all of the unoccupied portion of memory 504 may be arranged in page groups 515-M through 515-1 of pages having the same or similar endurance indicated by an endurance index. Page group 515-M may be active to receive new write data, and page groups 515-M-1 through 515-1 may be locked. New data to be written to memory 504 may be written to one or more pages in page group 515-M regardless of an access characteristic (e.g., frequency of use) of the data.

Within a page group 515, pages may be allocated (e.g., filled) using various techniques such as sequentially based on an address, randomly within a page group, in an order based on a finer-grained endurance characteristic, and/or the like, as described above with respect to the embodiment illustrated in FIG. 4.

As one or more pages in active page group 515-M fill with data, the scheme illustrated in FIG. 5 may unlock additional pages and/or page groups in order of an endurance index or other measure of a remaining lifespan of one or more pages. For example, referring to FIG. 5B, based on the amount of data stored in one or more pages in page group 515-M reaching or approaching a maximum capacity, one or more pages in page group 515-M-1 may be unlocked to store new write data. Depending on the implementation details, this may improve or optimize improve or optimize the reliability, lifespan, performance, and/or the like, of memory 504.

For purposes of illustration, some example embodiments may be described below in the context of an apparatus implemented with a storage device such as an SSD. Aspects of the disclosure, however, are not limited to storage devices and may be implemented, for example, with memory modules (e.g., DIMMs), thumb drives, and/or the like.

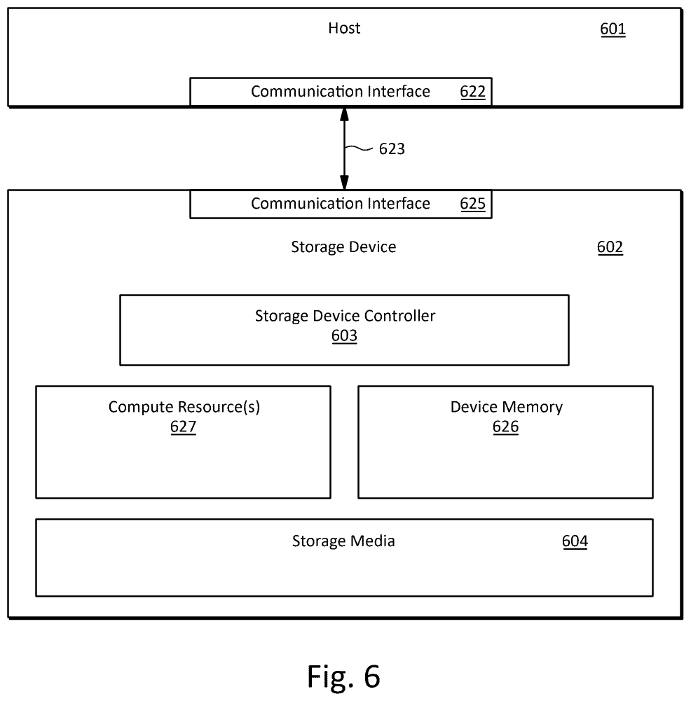

FIG. 6 illustrates an example embodiment of a system including a storage device that may implement one or more wear leveling techniques based on a data access characteristic and/or memory endurance characteristic in accordance with example embodiments of the disclosure. The system illustrated in FIG. 6 may include a host 601 and/or a storage device 602 that may communicate using a communication connection 623.

Host 601, which may include a communication interface 622, may be implemented with any component or combination of components that may utilize one or more features of a storage device 602. For example, a host may be implemented with one or more of a server, a storage node, a compute node, a central processing unit (CPU), a workstation, a personal computer, a tablet computer, a smartphone, and/or the like, or multiples and/or combinations thereof.

Storage device 602 may include a communication interface 625, memory 626 (some or all of which may be referred to as device memory), one or more compute resources 627 (which may also be referred to as computational resources), a storage device controller 603, and/or storage media 604. The storage device controller 603 and/or compute resources 627 may control the overall operation of the storage device 602 including any of the operations, features, and/or the like, described herein. For example, in some embodiments, storage device controller 603 may implement a scheme for using one or more memory pages based on a data access characteristic and/or memory endurance characteristic in accordance with example embodiments of the disclosure. Storage device controller 603 may be used to implement, or be implemented with, a device controller such as controller 203 illustrated in FIG. 2.

Referring to FIG. 6, storage media 604 may include any type of storage media, including solid state or other memory media that may have one or more characteristics (e.g., endurance characteristics) that may implement, and/or benefit from, wear leveling techniques including the techniques relating to data access characteristics, page endurance characteristics, and/or the like, disclosed herein. Examples may include NAND flash memory, NOR flash memory, PMEM such as cross-gridded nonvolatile memory, memory with bulk resistance change, PCM, and/or the like, or any combination thereof. Storage media 604 may be implemented with one or more devices (e.g., memory devices), for example, in a manner similar to the memory 204 illustrated in FIG. 2.

Storage device controller 603 may include a media translation layer such as an FTL for interfacing with one or more memory devices such as flash memory devices.

Compute resources 627 may be implemented with any component or combination of components that may perform operations on data that may be received, stored, and/or generated at storage device 602. Examples of compute resources may include combinational logic, sequential logic, timers, counters, registers, state machines, CPLDs, FPGAs, ASICs, embedded processors, microcontrollers, CPUs such as complex instruction set computer (CISC) processors (e.g., x86 processors) and/or a reduced instruction set computer (RISC) processors such as ARM processors, graphics processing units (GPUs), data processing units (DPUs), neural processing units (NPUs), tensor processing units (TPUs), and/or the like, that may execute instructions stored in any type of memory and/or implement any type of execution environment such as a container, a virtual machine, an operating system such as Linux, an Extended Berkeley Packet Filter (eBPF) environment, and/or the like, or a combination thereof.

Memory 626 may be used, for example, by one or more of storage device controller 603, compute resources 627, and/or the like, to store input data, output data (e.g., computation results), intermediate data, transitional data, and/or the like. Memory 626 may be implemented, for example, with volatile memory such as dynamic random access memory (DRAM), static random access memory (SRAM), and/or the like, as well as any other type of memory such as nonvolatile memory.

In some embodiments, storage device controller 603, memory 626, and/or compute resources 627 may include software, instructions, programs, code, and/or the like, that may be performed, executed, and/or the like, using one or more compute resources (e.g., hardware (HW) resources). Examples may include software implemented in any language such as assembly language, C, C++, and/or the like, binary code, FPGA code, one or more operating systems, kernels, environments such as eBPF, and/or the like. Software, instructions, programs, code, and/or the like, may be stored, for example, in a repository in memory 626 and/or compute resources 627. Software, instructions, programs, code, and/or the like, may be downloaded, uploaded, sideloaded, pre-installed, built-in, and/or the like, to the memory 626 and/or compute resources 627. In some embodiments, the storage device 602 may receive one or more instructions, commands, and/or the like, to select, enable, activate, execute, and/or the like, software, instructions, programs, code, and/or the like. Examples of computational operations, functions, and/or the like, that may be implemented by storage device controller 603, memory 626, compute resources 627, software, instructions, programs, code, and/or the like, may include any type of algorithm, data movement, data management, data selection, filtering, encryption and/or decryption, compression and/or decompression, checksum calculation, hash value calculation, cyclic redundancy check (CRC), weight calculations, activation function calculations, training, inference, classification, regression, and/or the like, for artificial intelligence (A/I), machine learning (ML), neural networks, and/or the like. Additional examples may include one or more operations to implement any of the wear leveling techniques based on a data access characteristic and/or memory endurance characteristic disclosed herein including, for example, determining an access characteristic (frequency of access) of data (e.g., using binning, histograms, and/or the like), determining an endurance characteristic of one or more pages of memory (e.g., by monitoring one or more error rates (e.g., using ECC), reading an indicator of endurance stored in memory), and/or the like.

Communication interface 622 at host 601, communication interface 625 at device 602, and/or communication connection 623 may implement, and/or be implemented with, one or more interconnects, one or more networks, a network of networks (e.g., the internet), and/or the like, or a combination thereof, using any type of interface, protocol, and/or the like. For example, the communication connection 623, and/or one or more of the interfaces 622 and/or 625 may implement, and/or be implemented with, any type of wired and/or wireless communication medium, interface, network, interconnect, protocol, and/or the like including Peripheral Component Interconnect Express (PCIe), Nonvolatile Memory Express (NVMe), NVMe over Fabric (NVMe-oF), Compute Express Link (CXL), and/or a coherent protocol such as CXL.mem, CXL.cache, CXL.io and/or the like, Gen-Z, Open Coherent Accelerator Processor Interface (OpenCAPI), Cache Coherent Interconnect for Accelerators (CCIX), and/or the like, Advanced extensible Interface (AXI), Direct Memory Access (DMA), Remote DMA (RDMA), RDMA over Converged Ethernet (ROCE), Advanced Message Queuing Protocol (AMQP), Ethernet, Transmission Control Protocol/Internet Protocol (TCP/IP), FibreChannel, InfiniBand, Serial ATA (SATA), Small Computer Systems Interface (SCSI), Serial Attached SCSI (SAS), iWARP, any generation of wireless network including 2G, 3G, 4G, 5G, 6G, and/or the like, any generation of Wi-Fi, Bluetooth, near-field communication (NFC), and/or the like, or any combination thereof. In some embodiments, a communication connection 623 may include one or more switches, hubs, nodes, routers, and/or the like.

Storage device 602 may be implemented in any physical form factor. Examples of form factors may include storage device (e.g., storage drive) form factors such as a 3.5 inch, 2.5 inch, 1.8 inch, and/or the like, form factor, M.2 device form factor, Enterprise and Data Center Standard Form Factor (EDSFF) (which may include, for example, E1.S, E1.L, E3.S, E3.L, E3.S 2T, E3.L 2T, and/or the like), add-in card (AIC) (e.g., a PCIe card (e.g., PCIe expansion card) form factor including half-height (HH), half-length (HL), half-height, half-length (HHHL), and/or the like), Next-generation Small Form Factor (NGSFF), NF1 form factor, compact flash (CF) form factor, secure digital (SD) card form factor, Personal Computer Memory Card International Association (PCMCIA) device form factor, and/or the like, or a combination thereof. Any of the computational devices disclosed herein may be connected to a system using one or more connectors such as SATA connectors, SCSI connectors, SAS connectors, M.2 connectors, EDSFF connectors (e.g., 1C, 2C, 4C, 4C+, and/or the like), U.2 connectors (which may also be referred to as SSD form factor (SSF) SFF-8639 connectors), U.3 connectors, PCIe connectors (e.g., card edge connectors), and/or the like.

Any of the storage devices 602 disclosed herein may be used in connection with one or more personal computers, smart phones, tablet computers, servers, server chassis, server racks, datarooms, datacenters, edge datacenters, mobile edge datacenters, and/or any combinations thereof.

In some embodiments, a storage device 602 may be implemented with any device that may include, or have access to, memory, storage media, and/or the like, to store data that may be processed by one or more compute resources 627. Examples may include memory expansion and/or buffer devices such as CXL type 2 and/or CXL type 3 devices, as well as CXL type 1 devices that may include memory, storage media, and/or the like.

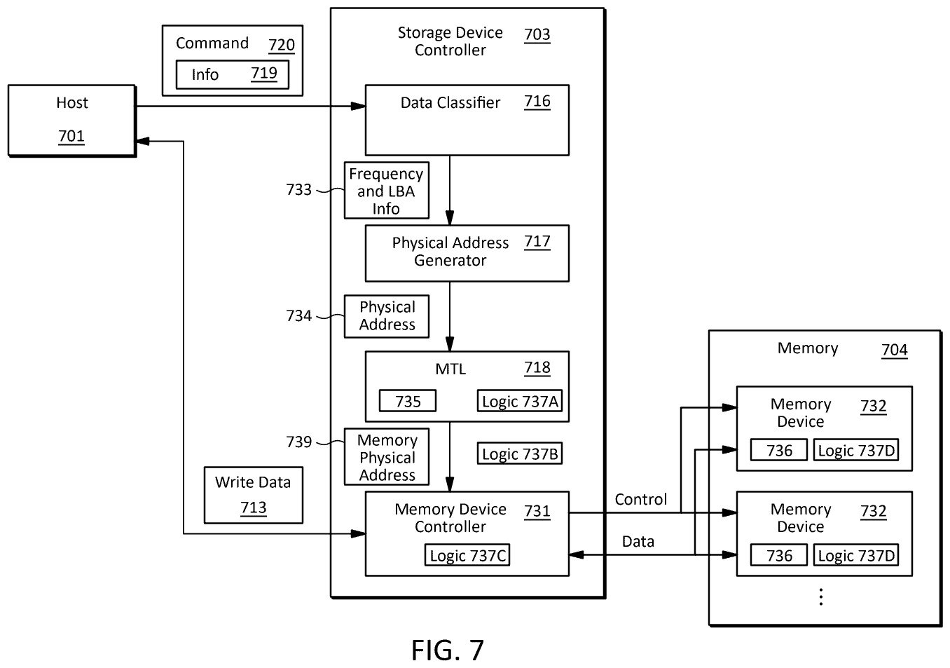

FIG. 7 illustrates an example embodiment of a storage device controller and related apparatus that may implement one or more wear leveling techniques based on one or more data access characteristics and/or memory endurance characteristics in accordance with example embodiments of the disclosure. The storage device controller 703 illustrated in FIG. 7 may be implemented with, or be used to implement, any controller disclosed herein such as controller 203 illustrated in FIG. 2 and/or device controller 603 illustrated in FIG. 6.

Storage device controller 703 may include a data classifier 716, a physical address generator 717, a media translation layer (MTL) 718, and/or a memory device controller 731, Data classifier 716 may receive information 719 (e.g., metadata, address information, and/or the like) from a host 701 about write data 713 to be written to memory 704. Information 719 may be received, for example, with a write command 720 from host 701. For purposes of illustration, the information 719 may be one or more LBAs for write data 713, but in other embodiments, data classifier 716 may use other types of information 719 (e.g., a hint from host 701) to classify or otherwise indicate an access characteristic of write data 713.

In some embodiments, data classifier 716 may determine a frequency of access of some or all of data stored in memory 704 by monitoring accesses such as reads and/or writes based on one or more LBAs of the data. For example, data classifier 716 may perform a binning operation that may cumulatively record one or more accesses (e.g., each accesses of data at one or more LBAs or range of LBA (e.g., each LBA or each range of LBAs)) to create a histogram representing access frequency (e.g., frequency of input (write) and/or output (read) (I/O or IO) operations) of data based on LBAs or ranges of LBAs. In some embodiments, a histogram may initially (e.g., at startup, reset, and/or the like) have little or no information on accesses but gradually build up a history of accesses to create a histogram indicating absolute and/or relative access frequency of data based on LBAs and/or ranges of LBAs. Additionally, or alternatively, data classifier 716 may determine a frequency of access of some or all of write data 713 from a source of the write data 713 (e.g., from host 701) which may provide an indication (e.g., a hint) representing a likely or expected access frequency of the write data 713.

Also based on receiving a write command 720, data classifier 716 may send information 733 including access frequency information and/or LBA information for write data 713 to physical address generator 717 which may use information 733 to generate one or more physical addresses 734 at which to store write data 713. In some embodiments, physical address generator 717 may implement a scheme for storing data in pages of memory based on access characteristics of the data and/or endurance characteristics of the pages of memory similar to the scheme illustrated in FIG. 4. For example, physical address generator 717 may generate one or more physical page addresses 734 corresponding to relatively strong pages of memory 704 for one or more portions of write data 713 that may be accessed relatively frequently. Additionally, or alternatively, physical address generator 717 may generate one or more physical page addresses 734 corresponding to relatively weak pages of memory 704 for one or more portions of write data 713 that may be accessed relatively infrequently.

In some embodiments, physical address generator 717 may obtain endurance information about pages of memory 704 from media translation layer 718 which may store information 735 about the relative and/or absolute strength of pages and/or page groups in one or more memory devices 732 within memory 704. In some embodiments, such information 735 may be determined based on a design of memory 704 and/or one or more memory devices 732. For example, relative and/or absolute wordline strengths may be known and/or estimated based on locations of wordlines within multiple layers of wordlines within a 3D NAND flash structure.

Additionally, or alternatively, physical address generator 717 may obtain endurance information 736 about pages of memory 704 from memory devices 732 within memory 704 which may store information 736 about the relative and/or absolute strength of pages and/or page groups in one or more memory devices 732. Information 735 and/or 736 may be in the form, for example, of one or more bar graphs similar to that illustrated with respect to FIG. 1. In some embodiments, such information 736 may be determined based on a manufacturing process of memory 704 and/or one or more memory devices 732. For example, in some embodiments, attributes of one or more wordlines in a memory device 732 (e.g., a NAND flash memory device) may be determined based on measurements, process parameters, and/or the like, from manufacturing a memory device 732 which may be stored, for example, in a special region of the memory device 732 similar to a special region that may be used to record defective blocks.

Additionally, or alternatively, physical address generator 717 may obtain endurance information about the relative and/or absolute endurance of pages and/or page groups in one or more memory devices 732 from logic 737 that may be located at one or more components illustrated in FIG. 7. For example, logic 737A, 737B, 737C, and/or 737D may be located at media translation layer 718, storage device controller 703, memory device controller 731, and/or one or more of memory devices 732, respectively. Logic 737 may be configured to determine endurance by monitoring and/or measuring one or more operations of pages and/or page groups. For example, logic 737 may monitor one or more ECC operations and determine the endurance of pages and/or page groups based on ECC failure rates for the pages and/or page groups. Pages and/or page groups having relatively high ECC failure rates may be designated as relatively weak, whereas pages and/or page groups having relatively low ECC failure rates may be designated as relatively strong (e.g., using an endurance index as described above).

Physical address generator 717 may send one or more physical page addresses 734 generated as described above to media translation layer (e.g., FTL) 718 which may register the one or more physical page addresses 734 in a logical-to-physical (L2P) address mapping (e.g., using a data structure such as an L2P mapping table). Additionally, or alternatively, media translation layer 718 may use the one or more physical page addresses 734 to convert one or more physical page addresses 734 to one or more memory physical addresses 739 (e.g., one or more NAND physical addresses in the case of memory devices 732 implemented with NAND flash memory). Additionally, or alternatively, media translation layer 718 may use the one or more physical page addresses 734 and/or memory physical addresses 739 to write corresponding write data 713 to one or more memory devices 732 (e.g., initiate a program operation on a nonvolatile memory device 732).

Using one or more memory page addresses 736, memory device controller 731 may initiate a data transfer operation (e.g., a DMA transfer) to transfer write data 713 from host 701 to memory device controller 731 which may control one or more memory devices 732 to write (e.g., program) write data 713 into one or more memory devices 732 at one or more pages determined by physical address generator 717.

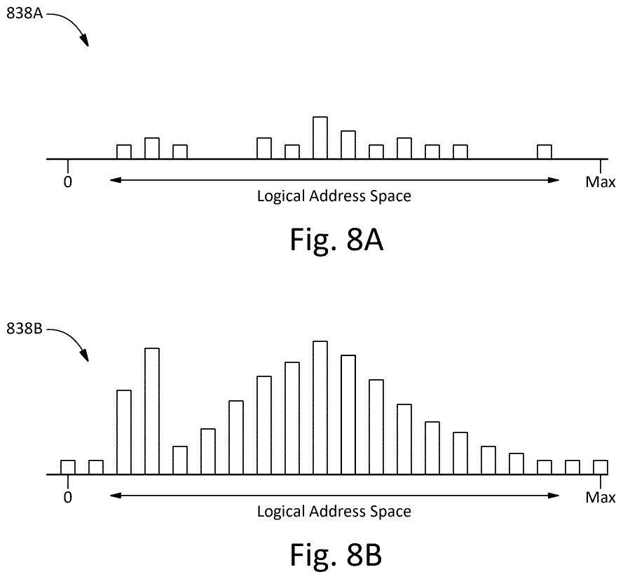

FIG. 8A illustrates an example histogram of accesses of pages in a memory at a first operating point in accordance with example embodiments of the disclosure. FIG. 8B illustrates the example histogram illustrated in FIG. 8A at a second operating point. Histogram 838 illustrated in FIG. 8 may be generated and/or used by any controller or component thereof disclosed herein, for example, the data classifier 716 and/or physical address generator 717 in controller 703 illustrated in FIG. 7. Histogram 838 may include bins of pages, page groups, and/or the like, arranged along the horizontal axis and corresponding to addresses (e.g., LBAs) starting at address zero at the left side and ending at a maximum address at the right side.

Referring to FIG. 8A, histogram 838A may represent access data available to a controller shortly after startup, installation, restart, and/or the like at which point relatively little access data may be available due to the relatively small number of access operations that may have occurred. In some embodiments, at least a portion of histogram 838 may be pre-populated by some expected or likely access frequency information that may be provided by a source such as a host.

Referring to FIG. 8B, histogram 838B may represent access data accumulated by a controller at a second operating point after a significant period of operation. In some embodiments, histogram 838B may continue to change based on changes in access frequency patterns of the memory address space represented by histogram 838B.

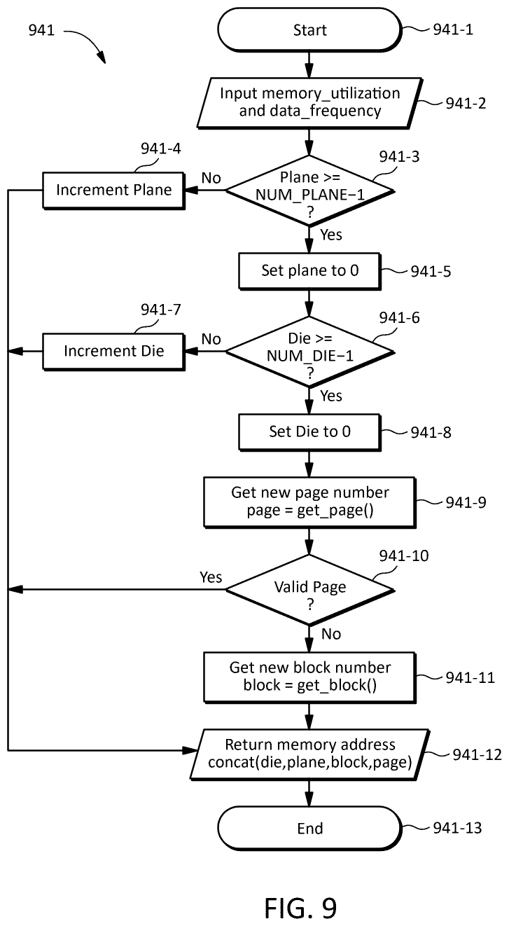

FIG. 9 illustrates an embodiment of a method for generating a page address in accordance with example embodiments of the disclosure. The address generation method 941 illustrated in FIG. 9 may be used, for example, by physical address generator 717 illustrated in FIG. 7 based on receiving a command 720 for write data 713.

Referring to FIG. 9, method 941 may be illustrated using one or more pseudocode elements including the name generate_address. Address generation method 941 may be used with a hierarchical die-plane-block-page address structure in which a memory device die may include one or more planes, one or more planes (e.g., each plane) may include one or more blocks, and one or more blocks (e.g., each block) may include one or more pages of memory. A die-plane-block-page address structure may be used, for example, with one or more flash memory devices.

The method 941 may begin at operation 941-1. At operation 941-2, the method may receive, as input, a memory utilization (memory_utilization) and/or a data frequency (data_frequency). The memory utilization may be expressed, for example, as a percentage utilization of a memory (e.g., memory 404 illustrated in FIG. 4, storage media 604 in storage device 602 illustrated in FIG. 6, and/or the like). The data frequency may be expressed, for example, as a number of accesses per unit of time for write data such as write data 713 illustrated in FIG. 7.

At operation 941-3, the method may compare a current plane number to a total number of planes (NUM_PLANE) minus one. If the current plane number is not greater than or equal to NUM PLANE−1, the method may increment the current plane number at operation 941-4 and proceed to operation 941-12 at which the method may return a memory address as the concatenation of the current die number, the incremented plane number, the current block number, and the current page number.

If, however at operation 941-3, the current plane number is less than NUM PLANE−1, the method may set the plane number to zero at operation 941-5 and proceed to operation 941-6 at which the method may compare the current die number to a total number of dies (NUM_DIE) minus one. If the current die number is not greater than or equal to NUM_DIE−1, the method may increment the die number at operation 941-7 and proceed to operation 941-12 at which the method may return a memory address as the concatenation of the incremented die number, the current plane number, the current block number, and the current page number.

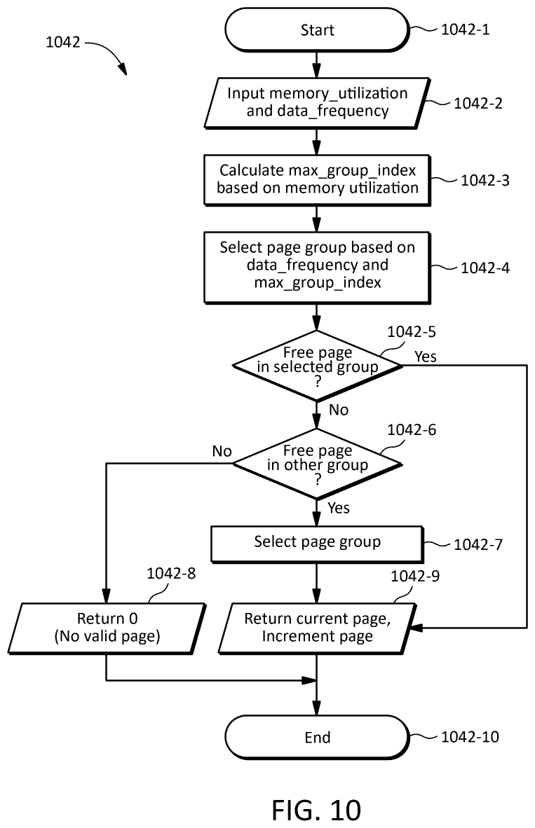

If, however, at operation 941-6, the current die number is less than NUM_DIE−1, the method may set the die number to zero at operation 941-8 and proceed to operation 941-9 at which the method may invoke a function (e.g., a get_page function as described below with respect to FIG. 10) to obtain a page number. In some embodiments, method 941 may pass one or more parameters to a get_page function such as a memory utilization and/or a data frequency that may be input to method 941 at operation 941-2.

At operation 941-10, the method may determine if a valid page number was returned at operation 941-9. If a valid page number was returned, the method may proceed to operation 941-12 at which the method may return a memory address as the concatenation of the current die number, the current plane number, the current block number, and the newly obtained page number.

If, however, at operation 941-10 the method determines that a valid page number was not returned, the operation may invoke a method (e.g., get_block) to obtain a new block number, The method may proceed to operation 941-12 at which the method may return a memory address as the concatenation of the current die number, the current plane number, the new block number, and the current page number. The method may end at operation 941-13.

FIG. 10 illustrates an embodiment of a method for generating a page number in accordance with example embodiments of the disclosure. The page number generation method 1042 illustrated in FIG. 10 may be used, for example, by physical address generator 717 illustrated in FIG. 7 based on receiving a command 720 for write data 713. The page number generation method 1042 may be invoked as a function, for example, by the address generation method 941 illustrated in FIG. 9. Page number generation method 1042 may be illustrated using one or more pseudocode elements including the name get_page. Page number generation method 1042 may be used with a hierarchical die-plane-block-page address structure as described above with respect to FIG. 9.

Referring to FIG. 10, method 1042 may begin at operation 1042-1. At operation 1042-2, the method may receive, as input, a memory utilization (memory_utilization) and/or a data frequency (data_frequency) which may be passed to method 1042 as one or more parameters by a calling function such at operation 941-9 of the address generation method 941 illustrated in FIG. 9. The memory utilization may be expressed, for example, as a percentage utilization of a memory (e.g., memory 404 illustrated in FIG. 4, storage media 604 in storage device 602 illustrated in FIG. 6, and/or the like). The data frequency may be expressed, for example, as a number of accesses per unit of time for write data such as write data 713 illustrated in FIG. 7.

Referring again to FIG. 10, at operation 1042-3, the method may calculate a maximum page group index (e.g., max_group_index) based on a memory utilization. For example, if the method illustrated in FIG. 10 is used with the scheme illustrated in FIG. 4A, the maximum page group index may be calculated as 15.

At operation 1042-4, the method may select a page group based on a data frequency and/or a maximum page group index as calculated at operation 1042-3. For example, in the context of the examples illustrated with respect to FIG. 4A and/or FIG. 7, if write data 713 includes relatively frequently accessed data, and memory 404 has a utilized portion 409, operation 1042-4 may select page group 415-M. If, however, write data 713 includes relatively infrequently accessed data, and memory 404 has a utilized portion 409, operation 1042-4 may select page group 415-1.

At operation 1042-5, the method may determine if a page group selected at operation 1042-4 has at least one free page. If at least one free page is available in the selected page group, the method may proceed to operation 1042-9 which may allocate and return a page with the selected page group for storage of write data 713. In some embodiments, pages within a page group may be allocated sequentially (e.g., by address) within the group. In such embodiments, operation 1042-9 may return the current page and increment the page for the next time method 1042 proceeds through operation 1042-9. In some other embodiments, pages within a page group may be allocated randomly. In yet other embodiments, pages within a page group may be allocated based on a finer-grained endurance.

If, however, at operation 1042-5, a free page is not available within the page group selected at operation 1042-4, the method may proceed to operation 1042-6 where the method may determine if any remaining page group has at least one free page. If a remaining page group has at least one free page available, the method may proceed to operation 1042-7 where it may select a page group for data having a lower access frequency and/or a page having a lower endurance index. For example, in the embodiment illustrated in FIG. 4B, if page group 415-M is selected but does not have a free page available, the method may select page group 415-M-1. From operation 1042-7, the method may proceed to operation 1042-9 which may return the current page from the selected page group and increment the page for the next time method 1042 proceeds through operation 1042-9. Thus, once a group's pages are exhausted, the function may transition to the next available page group which may be mapped to a weaker page.

If, however, at operation 1042-6, a page group having a free page is not available, the method may proceed to operation 1042-8 where it may return a result (e.g., zero) that may indicate that a page group having a free page is not available.

From operation 1042-8 or 1042-9, the method may proceed to operation 1042-10 where the method may end.

The embodiments illustrated in FIG. 9 and/or FIG. 10, as well as all of the other embodiments described herein, are example operations and/or components. In some embodiments, some operations and/or components may be omitted and/or other operations and/or components may be included. Moreover, in some embodiments, the temporal and/or spatial order of the operations and/or components may be varied. Although some components and/or operations may be illustrated as individual components, in some embodiments, some components and/or operations shown separately may be integrated into single components and/or operations, and/or some components and/or operations shown as single components and/or operations may be implemented with multiple components and/or operations,

Any of the functionality described herein, including any of the host functionality, device functionally, and/or the like, as well as any of the functionality described with respect to the embodiments illustrated in FIGS. 1-10 may be implemented with hardware, software, firmware, or any combination thereof including, for example, hardware and/or software combinational logic, sequential logic, timers, counters, registers, state machines, volatile memories such DRAM and/or SRAM, nonvolatile memory including flash memory, persistent memory such as cross-gridded nonvolatile memory, memory with bulk resistance change, PCM, and/or the like and/or any combination thereof, complex programmable logic devices (CPLDs), FPGAs, ASICs, CPUs including CISC processors such as x86 processors and/or RISC processors such as ARM processors, GPUs, NPUs, TPUs, and/or the like, executing instructions stored in any type of memory. In some embodiments, one or more components may be implemented as a system-on-chip (SOC), a multi-chip module, one or more chiplets (e.g., integrated circuit (IC) dies) in a package, and/or the like.

Some embodiments disclosed above have been described in the context of various implementation details, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

Since the inventive principles of this patent disclosure may be modified in arrangement and detail without departing from the inventive concepts, such changes and modifications are considered to fall within the scope of the following claims.

1. A device comprising:
a memory; and
a device controller configured to perform an operation comprising storing, in a page of the memory, data;
wherein the storing the data is based on:
an access characteristic of the data; and
an endurance characteristic of the page of the memory.

2. The device of claim 1, wherein:
the access characteristic comprises an access frequency; and
the endurance characteristic comprises a number of program cycles.

3. The device of claim 1, wherein the data comprises first data, the page of the memory is a first page of the memory, the access characteristic is a first access characteristic, the endurance characteristic is a first endurance characteristic, and the device controller is configured to perform one or more operations comprising:
storing, in a second page of the memory, second data;
wherein the storing the second data is based on:
a second access characteristic of the second data; and
a second endurance characteristic of the second page of the memory.

4. The device of claim 1, wherein the device controller is configured to determine the endurance characteristic of the page of the memory based on at least one of an indication or a structure of the memory.

5. The device of claim 1, wherein the device controller is configured to determine the endurance characteristic of the page of the memory based on monitoring the page of the memory.

6. The device of claim 1, wherein the device controller is configured to determine the access characteristic of the data based on monitoring one or more accesses of the data.

7. The device of claim 1, wherein the device controller is configured to:
receive an indication; and
determine the endurance characteristic of the page of the memory based on the indication.

8. The device of claim 1, wherein the storing the data is further based on a utilized amount of the memory.

9. The device of claim 1, wherein the data comprises first data, the page of the memory comprises a first page of the memory, and the device controller is further configured to perform one or more operations comprising:
storing, in a second page of the memory, second data;
wherein the first page of the memory is determined based on a first utilized amount of the memory, and the second page of the memory is determined based on a second utilized amount of the memory.

10. The device of claim 1, wherein the device controller is configured to perform, based on the storing the data, a garbage collection operation on the page of the memory.

11. A device comprising:
a memory comprising a first page having a first endurance characteristic and a second page having a second endurance characteristic; and
a device controller configured to perform one or more operations comprising:
storing, in the first page of the memory, based on a first utilized amount of the memory, first data; and
storing, in a second page of the memory, based on a second utilized amount of the memory, second data.

12. The device of claim 11, wherein:
the storing the first data is based on a first access characteristic of the first data; and
the storing the second data is based on a second access characteristic of the second data.

13. The device of claim 11, wherein the device controller is further configured to perform one or more operations comprising:
operating, based on the first utilized amount of the memory, a first group of pages of the memory comprising the first page of the memory; and
operating, based on the second utilized amount of the memory, a second group of pages of the memory comprising the second page of the memory.

14. The device of claim 13, wherein the first group of pages is based on one or more of a structure of the memory or an indication stored in the memory.

15. A method comprising:
storing, in a page of a memory, data;
wherein the storing the data is based on:
an access characteristic of the data; and
an endurance characteristic of the page of the memory,

16. The method of claim 15, wherein the data comprises first data, the page of the memory is a first page of the memory, the access characteristic is a first access characteristic, the endurance characteristic is a first endurance characteristic, the method further comprising:
storing, in a second page of the memory, second data;
wherein the storing the second data is based on:
a second access characteristic of the second data; and
a second endurance characteristic of the second page of the memory.

17. The method of claim 15, wherein the endurance characteristic of the page of the memory is based on at least one of a structure of the memory, an indication, or monitoring the page of the memory.

18. The method of claim 15, wherein the access characteristic of the data based on one or more of an indication or monitoring one or more accesses of the data.

19. The method of claim 15, wherein the storing the data is further based on a utilized amount of the memory.

20. The method of claim 15, wherein the data comprises first data, and the page of the memory comprises a first page of the memory, the method further comprising:
storing, in a second page of the memory, second data;
wherein the first page of the memory is based on a first utilized amount of the memory, and the second page of the memory is based on a second utilized amount of the memory.
